(19) United States
(12) Patent Application Publication
(10) Pub. No.: US 2015/0149746 A1
(43) Pub. Date: May 28, 2015

(54) ARITHMETIC PROCESSING DEVICE, INFORMATION PROCESSING DEVICE, AND A METHOD OF CONTROLLING THE INFORMATION PROCESSING DEVICE

(71) Applicant: FUJITSU LIMITED, Kawasaki-shi (JP)

(72) Inventors: Makoto SUGA, Edogawa (JP); AKIO TOKOYODA, FUCHU (JP); Koji HOSOE, Yamato (JP); Masatoshi Aihara, Hiratsuka (JP); Yuta Toyoda, Kawasaki (JP)

(21) Appl. No.: 14/536,763

(22) Filed: Nov. 10, 2014

(30) Foreign Application Priority Data
Nov. 26, 2013 (JP) 2013-243992

(51) Int. Cl. G06F 9/30

(52) U.S. Cl. CPC G06F 9/3001; G06F 9/30145
USPC 712/221

(57) ABSTRACT

An arithmetic processing device promotes transmission efficiency between a processor and a memory. The arithmetic processing device has an arithmetic processing unit which issues an instruction accompanying with data which is sent to the memory, a judgment unit which judges whether or not a redundancy degree of the data which is accompanied with the instruction is more than a predetermined value, a compression unit which judges whether or not compress the data based on an waiting time and a compression time when the redundancy degree of the data is more than the predetermined value, and compress the data when judging that performs the compression, and an instruction arbitration unit which transfers the instruction accompanying with the compressed data to the memory when the compression unit performs the compression and transfers the instruction accompanying with the non-compressed data to the memory when the compression unit does not perform the compression.

### CROSS-REFERENCE TO RELATED APPLICATION

This application is based upon and claims the benefit of priority of the prior Japanese Patent Application No. 2013-243992, filed on Nov. 26, 2013, the entire contents of which are incorporated herein by reference.

### FIELD

The embodiments discussed herein are related to an arithmetic processing device, an information processing device, and a method of controlling the information processing device.

### BACKGROUND

In order to improve the processing throughput of the processor to the memory, there is a technique for compressing the data of the store instruction and the like and transferring the compressed data to the memory.

Examples are described a case where a fetch instruction follows to a store instruction. When the amount of data to be stored by the store instruction is large, it takes to transfer the store instruction more time. Accordingly, there may be that a delay time, which is a waiting time until start of transferring the subsequent fetch instruction, is increased. In order to avoid the increase of the delay time, the arithmetic processing device compresses the data of the store instruction, and transfers the compressed data to the memory. Therefore, the transfer time of a store instruction becomes short, thereby reducing the delay time of the subsequent fetch instruction as a result.

For example, the compression of data is realized by the integrated circuit (as described in, for example, following Patent Documents 1 to 4).
[Patent document 1] Japanese Laid-open Patent publication No. 2004-206228.
[Patent Document 2] Japanese Laid-open Patent publication No. Hei 5-189360.
[Patent Document 3] Japanese Laid-open Patent publication No. Hei 7-202983.
[Patent Document 4] Japanese Laid-open Patent publication No. Hei 7-168671.

### SUMMARY

When the clock frequency of the processor is high, it is preferable to use an integrated circuit which has a high compressibility of the data, because there is the need to transfer data in 1 clock. However, in the high compressibility integrated circuit, the circuit scale grows big by increasing latches, and the consumption electricity increases. Because the processing time of the circuit, which has a large scale, becomes a long, a completion of the compression processing of data may not be in a time of the transfer start of the store instruction by compressing the data.

In addition, according to the conventional description, for example, it is determined whether the compressed data or the original data is transferred by comparing the size of data before and after the compression after the compression of data was completed. In other words, in a series of processing of the store instruction, it is determined whether the compressed data or the original data is transferred after the compression of data. Therefore, not only it takes time until the determination of the transfer the compressed data, but also time to consume the compression process of data is wasted when determining that the compress data is not transferred after the compression of data. By these processes, it is difficult to improve data transfer rate in the memory band width between the processor and the memory.

According to a first aspect of the embodiment, An arithmetic processing device includes an arithmetic processing unit configured to issue an instruction accompanying with data which is sent to a memory, a judgment unit configured to judge whether or not a redundancy degree of the data which is accompanied with the instruction is more than a predetermined value, a compression unit configured to judge whether or not compress the data based on an waiting time until a transfer start of the instruction to the memory and a compression time to take the compression of the data when the redundancy degree of the data is more than the predetermined value, and compress the data when judging that performs the compression; and an instruction arbitration unit configured to transfer the instruction accompanying with the compressed data from the arithmetic processing unit to the memory when the compression unit performs the compression and transfer the instruction accompanying with the non-compressed data from the arithmetic processing unit to the memory when the compression unit does not perform the compression.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a diagram of example of a construction in the information processing device according to an embodiment.

FIG. 2 depicts a diagram indicating an example of a constitution of the memory control unit 23 indicated by FIG. 1.

FIG. 3 is a diagram indicating an example of packets p0-pn of the instruction (for example, the store instruction) to send out the data depicted by FIG. 2 to the memory 30.

FIG. 4A and FIG. 4B are diagram explaining an example of the compression of data.

FIG. 5 is a diagram explaining a flow of the determination process when determining the effect or no-effect that the compression has performed.

FIG. 6 is a diagram explaining judgment process of the redundancy of the data that the temporarily store unit 31 in the memory control unit 23 performs according to the embodiment.

FIG. 7 is a diagram explaining an example of the hardware constitution of the compression judgment flag generation logical circuit 34.

FIG. 8 is a flow diagram explaining that the compression judgment unit 61 of the memory control unit 23 (referring to FIG. 2) executes the processing of the correct or incorrect judgment process of the compression of data according to the embodiment.

FIG. 9 is a timing chart diagram explaining the specific example of process S31 in FIG. 8 (the compression availability judgment process of the data) according to the embodiment.

FIG. 10 is a timing chart diagram explaining another specific example of process S31 in FIG. 8 (the compression availability judgment process of the data) according to the embodiment.

### DESCRIPTION OF EMBODIMENTS

(Information Processing Device)

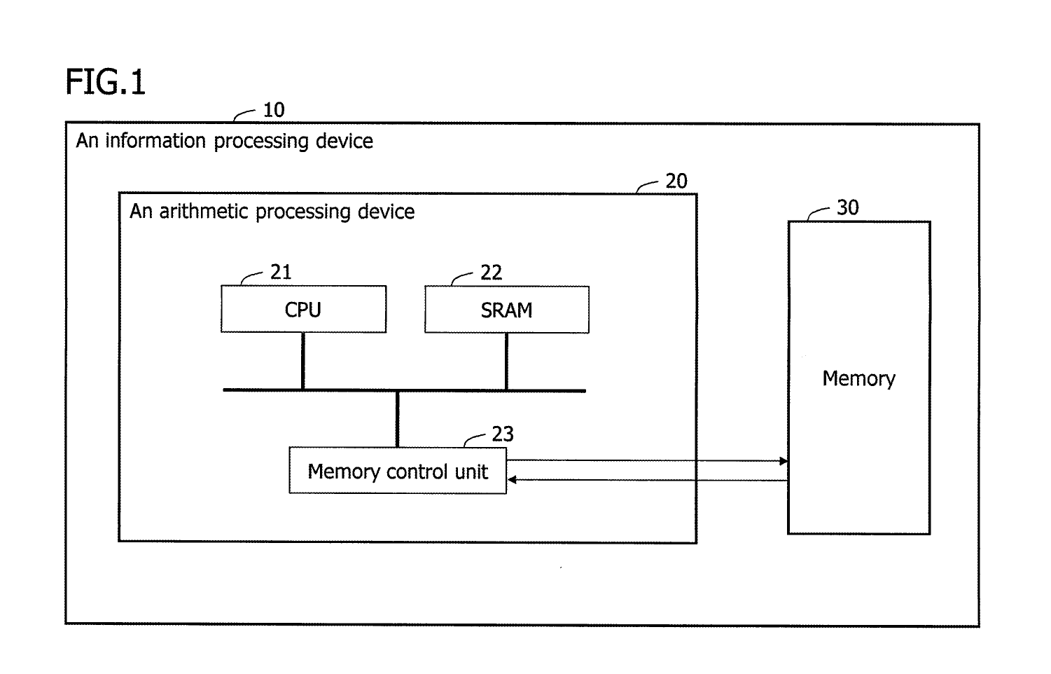

FIG. 1 illustrates a diagram of example of a construction in the information processing device according to an embodiment. The information processing device 10 depicted by FIG. 1 is a computer such as a server, for example.

In FIG. 1, the information processing device 10 includes an arithmetic processing device 20 and a memory 30, for example. In addition, the arithmetic processing device 20 has a CPU (Central Processing Unit) 21, a SRAM (Static Random Access Memory) 22 and a memory control unit 23, for example. The memory control unit 23 transfers an instruction transmitted from the CPU 21 to the memory 30 and sends the data which is read from the memory 30 to the CPU 21. The memory control unit 23 according to the embodiment targets the instruction accompanying with the data, which is sent to the memory 30, among the instructions accessing to the memory 30, judges whether the compression of the data for the target instructions is performed, and compresses the data based on the judgment result.

(Memory Control Unit)

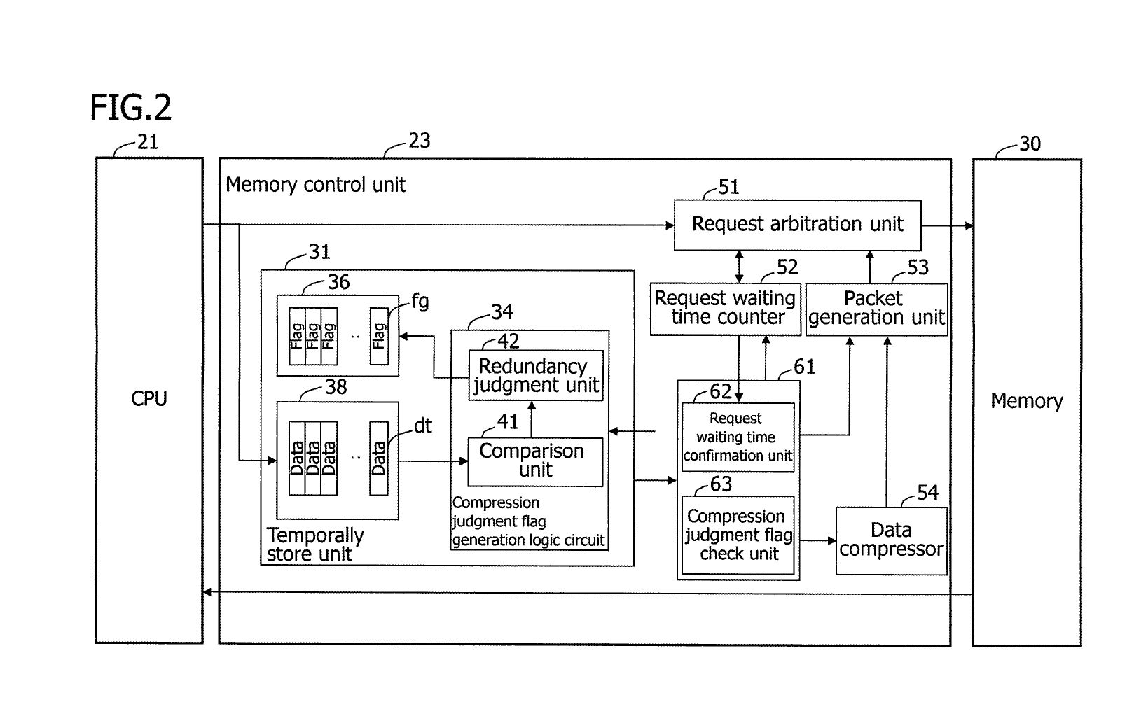

FIG. 2 depicts a diagram indicating an example of a constitution of the memory control unit 23 indicated by FIG. 1. For example, the memory control unit 23 in FIG. 2 includes a temporarily store unit 31, a request arbitration unit 51, a request waiting time counter 52, a packet generation unit 53, a compression judgment unit 61 and a data compressing device 54.

The request arbitration unit 51 arbitrates two or more requests of the instructions, which is not completed to transfer to the memory 30, in the instructions which are transferred to the memory 30 (for example, a store instruction and a fetch instruction). The request arbitration unit 51 holds one or more instructions that are completed to transfer to the memory 30, as queues such as FIFO (First In First Out memory).

For example, when a store instruction with much quantity of data is issued, the sending out time to the memory 30 for the data becomes longer, thereby it takes a time to transfer the instruction. For example, when a different store instruction and a fetch instruction are issued to follow the store instruction with much quantity of the data, the request arbitration unit 51 holds the following instruction in the queues, and requests the following instruction according to a completion of the transfer of the precedent instruction. Therefore, a waiting time may occur until the start of the request of the instruction.

The request waiting time counter 52 holds the total of the transfer time of the instructions, which are held in the queues in the request arbitration unit 51 and are not completed to transfer, as the request waiting time. In other words, the request waiting time counter 52 holds the waiting time until the transfer start of a following instruction issued newly as a counting time. The transfer time for each instruction is detectable beforehand. When a new instruction is added to the queues, the request arbitration unit 51 counts up the request waiting time counter 52 for the time that the transfer of the instruction takes. In addition, when the transfer of the instruction held in the queue has completed, the request arbitration unit 51 counts down the request waiting time counter 52 for the transfer time of the instruction concerned.

The temporarily store unit 31 stores temporarily data “dt” in a data memory 38 when the instruction accompanying with the data (for example, a store instruction) to send out to the memory 30 was issued, judges a redundancy degree of same data pattern (for example, mismatching rate of same data pattern) in the data “dt”, generates a compression judgment flag “fg” and outputs it to the compression judgment unit 61. For example, the temporarily store unit 31 has the data memory 38 which stores data “dt”, a flag memory 36 which stores the compression judgment flag “fg” which the instruction has and a compression judgment flag generation logical circuit 34. The compression judgment flag generation logical circuit 34 judges whether the data “dt” has a redundancy degree of same data pattern more than a predetermined value, and outputs the compression judgment flag “fg” which has a second predetermined value when the data “dt” has the redundancy degree of same data pattern more than the predetermined value. The compression judgment flag generation logical circuit 34 has a comparison unit 41 and a redundant judgment unit 42. The comparison unit 41 detects the redundancy degree of the data “dt” and the redundant judgment unit 42 judges the redundancy degree of the data “dt” by comparing the threshold with the comparison result, and outputs the compression judgment flag “fg”.

The compression judgment unit 61 has a request waiting time confirmation unit 62 and a compression judgment flag check unit 63. The compression judgment flag check unit 63 determines whether the compression judgment flag “fg” has the second predetermined value and the request waiting time confirmation unit 62 judges whether the compression of the data for the instruction, that the compression judgment flag “fg” has the second predetermined value, is performed based on the waiting time of the request waiting time counter 52.

The compression judgment unit 61, when judging to compress the data, outputs the data to the data compressing device 54. The data compressing device 54 compresses the input data and outputs the compressed data to the packet generation unit 53. In addition, the compression judgment unit 61, when judging to compress the data, updates the request waiting time counter 52, because the transfer time of the instruction changes according to data quantity. In addition, the compression judgment unit 61, when judging not to compress the data, outputs the data of the non-compression to the packet generation unit 53. The packet generation unit 53 generates a packet based on input data.

(Packet)

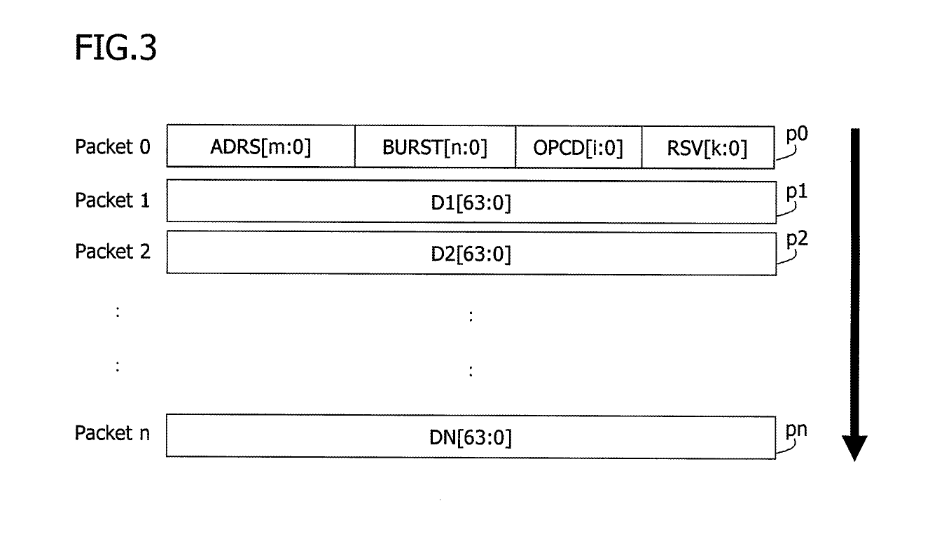

FIG. 3 is a diagram indicating an example of packets p0-pn of the instruction (for example, the store instruction) to send out the data depicted by FIG. 2 to the memory 30. In the example of FIG. 3, the size of each of packets p0-pn is 64 bit and the packets p0-pn include a first packet p0 having header information and second packets p1-pn including data targeted for processing of the instruction as a payload. For example, the header information includes address information and data length, classification of the instruction, a compression form, etc. Each packet is transmitted sequentially from the packet p0 to the packet pn.

As depicted by FIG. 3, the header information has information ADRS, information BURST, information OPCD, and information RSV. The information ADRS indicates an address of memory 30. And the bit width (0˜m=m+1 byte) of the address varies according to the memory 30 to be equipped with. The information BURST indicates the length of the data. In addition, the information OPCD indicates the classification of instructions such as the store or the fetch. The information RSV indicates a reserve area and has the information such as a compression form. In addition, each of the packet p1—the packet pn include data targeted for the compression as a payload.

(Compression of Data)

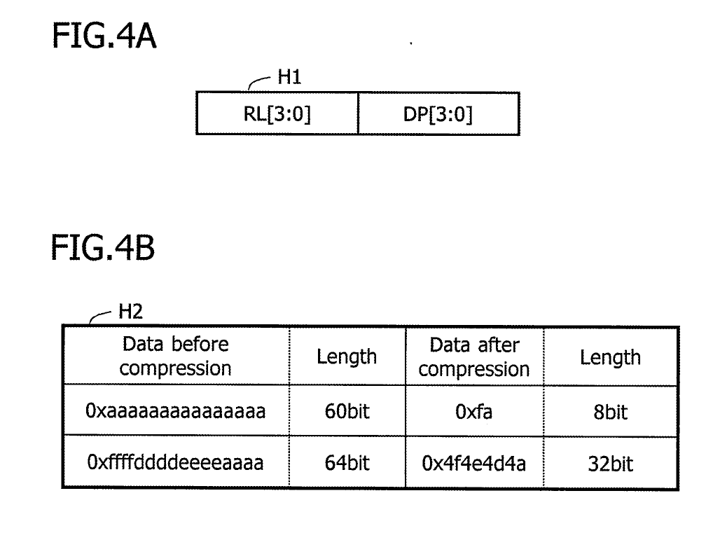

FIG. 4A and FIG. 4B are diagram explaining an example of the compression of data. The example of FIG. 4A and FIG. 4B represent run-length encoding as a compression method. FIG. 4A indicates the data format H1 of the run length encoding and FIG. 4B indicates the encoding example H2 of the data.

The run length encoding realizes compression by converting the data into data of the data format H1 in FIG. 4. The data format H1 of the run length encoding has a data format RL [3:0] (=4 bit) and a data format DP [3:0] (=4 bit), for example. The data format DP indicates data pattern, and the data format RL indicates the number of times that the data pattern concerned is repeated.

The run length encoding will be described in the example of the data “0xaaaaaaaaaaaaaaa” for the compression target. In the data “0xaaaaaaaaaaaaaaa” for the compression target, mark “0x” represents that the data is a hexadecimal notation and value “a” is a hexadecimal value. Accordingly, the data “0xaaaaaaaaaaaaaaa” is constructed by 15 (decimal notation, hexadecimal value=f) pieces of data pattern “0xa”. Therefore, the data after the compression become “0xfa” when the data “0xaaaaaaaaaaaaaaa” is encoded by the run length encoding. In the data “0xfa” after the compression, the value “0xf” indicates the data format RL (repeating number) and the value “0xa” indicates the data format DP (data pattern). In other words, the data “0xfa” after the compression represents that the data pattern “0xa” continues a “0xf” (=15: decimal notation) pieces. In this case, the total repeating number of same data pattern is 15 (that is, matching rate of 4 bit data=100%, mismatching rate=0%). Because the data length of data “0xaaaaaaaaaaaaaaa” is 60 bit (=4 bit*15) and the data length of data “0xfa” is 8 bit (f=a=4 bit), by the encoding, the data length decreases in 8 bit from 60 bit.

Similarly, the run length encoding will be described in the example of the data “0xffffddddeeeeaaaa” for the compression target. In the data “0xffffddddeeeeaaaa” for the compression target, mark “0x” represents that the data is a hexadecimal notation and values “f”, “d”, “e” and “a” are hexadecimal value. Accordingly, the data “0xffffddddeeeeaaaa” is constructed by four (decimal notation, hexadecimal value=4) pieces of data pattern “0xf”, four (decimal notation, hexadecimal value=4) pieces of data pattern “0xd”, four (decimal notation, hexadecimal value=4) pieces of data pattern “0xe” and four (decimal notation, hexadecimal value=4) pieces of data pattern “0xa”. Therefore, the data after the compression become “0x4f4d4e4a” when the data “0xffffddddeeeeaaaa” is encoded by the run length encoding. Because the data length of data “0xffffddddeeeeaaaa” is 64 bit (=4 bit*16) and the data length of data “0x4f4d4e4a” is 32 bit, by the encoding, the data length decreases in 32 bit from 64 bit. In other words, by the encoding, the data length becomes ½.

As depicted by FIG. 4B, when the data includes redundancy data pattern, according to the run length encoding, it is possible to decrease the data length. Therefore, it is possible to decrease the number of packets of the instruction as depicted by FIG. 3, for example.

On the other hand, according to the run length encoding, the data length may not decrease depending on the contents of data. For example, the run length encoding will be described in the example of the data “0xabcddddd” for the compression target. In the data “0xabcddddd” for the compression target, mark “0x” represents that the data is a hexadecimal notation and values “a”, “b”, “c” and “d” are hexadecimal value. The data length of data “0xabcddddd” is 32 bit (=4 bit*8) and the total repeating number of same data pattern is 5. Therefore, the data after the compression become “0x1a1b1c5d” when the data “0xabcddddd” is encoded by the run length encoding. The data length of data “0x1a1b1c5d” is 32 bit, by the encoding. Therefore, the data length by the encoding does not decrease according the contents of the data. Furthermore, for example, when the 32 bit data “0xabcdeeee” is run length encoding, the encoded data is data “0x1a1b1c1d4e” and is 40 bit. Therefore, the data length increases by the contents of data as a result of encoding.

As depicted by the run length encoding in FIG. 4A and FIG. 4B, by the compression of data, the data length may not decrease. Therefore, as one example, the arithmetic processing device 20 judges whether the data length decreased after compressing the data and determines whether the compressed data is transferred or not (effect or no-effect that the compression has performed) based on the result of the judgment. Then, the determination process will be explained.

(Determination of Effect or No-Effect that the Compression has Performed)

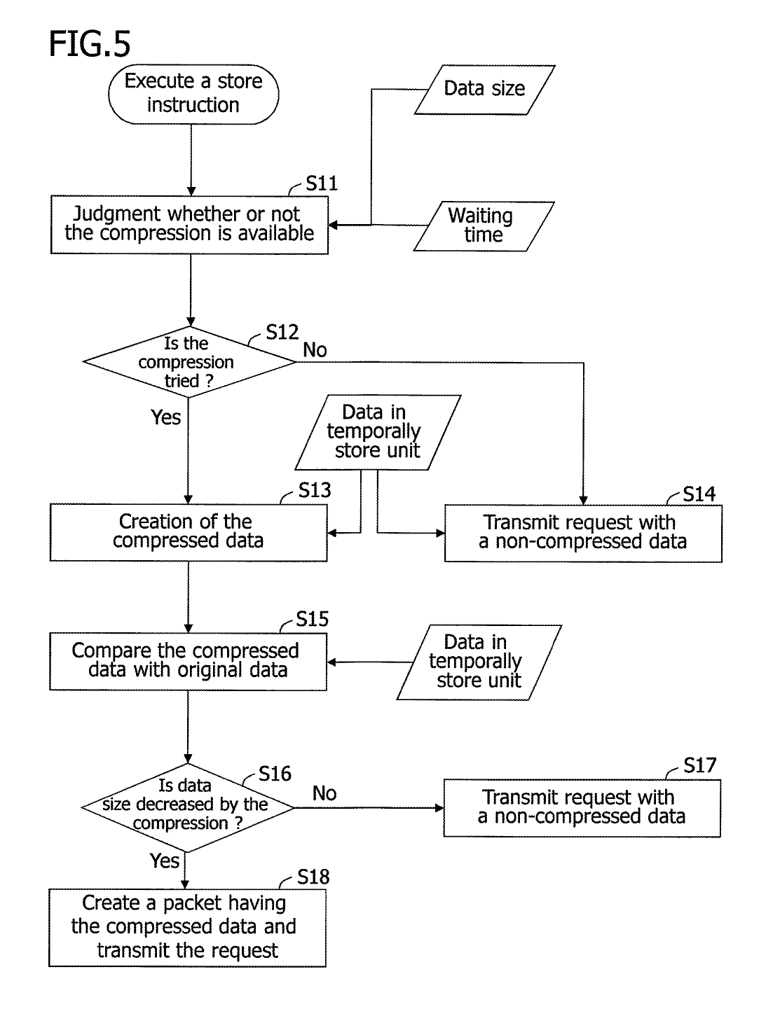

FIG. 5 is a diagram explaining a flow of the determination process when determining the effect or no-effect that the compression has performed. In addition, the example in FIG. 5 indicates a case of the store instruction.

The arithmetic processing unit judges whether the compression of the data which are the target of the store instruction is performed based on the data size and the waiting time (S11) to try the compression. The arithmetic processing unit judges that the compression is possible when completing the compression of the data during the waiting time (S12/YES). The arithmetic processing device does not try the compression of data when it is judged to be impossible of compression (S12/NO), and requests the store instruction based on a non-compressed data held in the temporarily store unit (S14).

On the other hand, the arithmetic processing device, when judging that the compression is possible (S12/YES), tries the compression (compresses the held in the temporarily memory unit) and creates a compressed data (S13). Then the arithmetic processing device compares the size of the original data before the compression with the size of the compressed data (S15). When the size of the compressed data is smaller than the size of the original data, in other words, when the size of data decreases by the compression (S16/YES), the arithmetic processing device creates a packet to include the compressed data as a payload and requests the store instruction (S18).

And when the size of data does not decrease by the compression (S16/NO), the arithmetic processing device creates a packet to include the non-compressed data as a payload and requests the store instruction (S17). As described in FIG. 4A and FIG. 4B, the data length may not decrease even if performing the compression of the data. Therefore, the arithmetic processing device performs a trial of the compression of data. And the arithmetic processing device performs the determination of the correct or incorrect that the compression has performed, based on a size of the data before and after compression. Accordingly, in the example of FIG. 5, it takes a time until the determination of the effect or no-effect that the compression has performed, because executing the determination of the effect or no-effect that the compression has performed after compressing the data.

While, in the embodiment, the arithmetic processing device 20, before the compression of the data, judges whether the redundancy degree (the total repeating number of same data pattern=matching rate of unit data) of the data of the instruction (for example, the store instruction), which accompanying with the data to send out to the memory, is more than a predetermined value and determines whether the compression of the data is performed about the instruction which the redundancy degree of the data is more than the predetermine value. In addition, the arithmetic processing device 20 judges whether or not compresses the data based on the waiting time until a transfer start to the memory and the compression time to take time to compress the data to be concrete and performs the compression of the data when judging to perform the compression. In addition, the arithmetic processing device 20 judges whether or not compresses the data based on a transfer time of the compressed data after compression to the memory and a transfer time of the original data to the memory.

In this way, it is possible that the arithmetic processing device 20 easily judges whether the data have the compressibility corresponding to the predetermined value based on whether the redundancy degree of the data is more than a predetermined value without compressing data. Therefore, it is possible that the arithmetic processing device 20 judges the correct or incorrect that performs the compression of data without compressing data with a high speed and it is possible to avoid unnecessary compression processing. In other words, it is possible that the arithmetic processing device 20 judges whether the compression is performed easily and immediately. Therefore, it is possible that the arithmetic processing device 20 promotes efficiency of data transmission with the CPU 21 and the memory 30.

(Judgment of Redundancy Degree of Data)

Firstly, the processing (the redundancy is high or low), which judges whether the redundancy degree of the data is more than a predetermined value about the instruction accompanying with data to send out to the memory 30, will be explained. In addition, the instruction accompanying with the data to send out to the memory is not limited to the store instruction, but included an atomic instruction, etc.

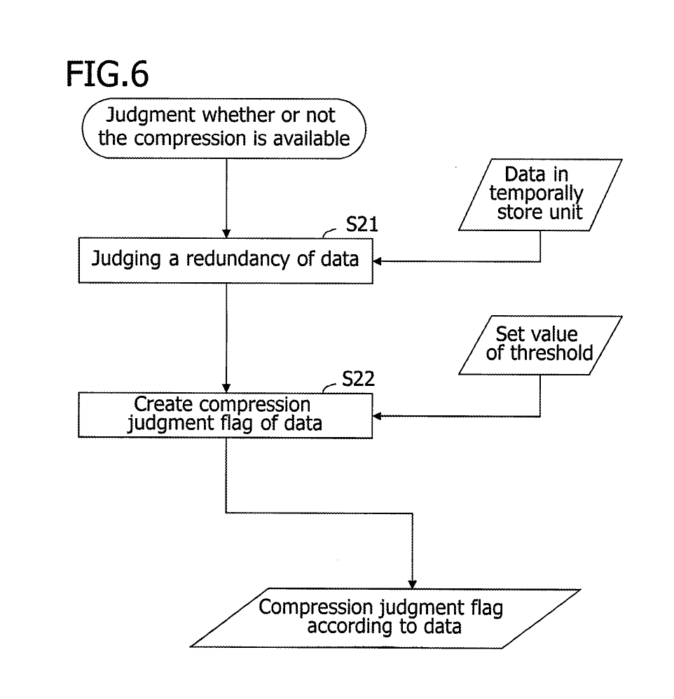

FIG. 6 is a diagram explaining judgment process of the redundancy of the data which stored in the temporarily store unit 31 of the memory control unit 23 according to the embodiment. When the instruction accompanying with the data to send out from the CPU 21 to the memory 30 is issued, the data are stored in the temporarily store unit 31.

The compression judgment flag generation logical circuit 34 in the temporarily store unit 31 detects and judges the redundancy degree of stored data when the data are stored in the data memory 38 of the temporarily store unit 31 (S21). Then, the compression judgment flag generation logical circuit 34 outputs the compression judgment flag “fg” indicating the judgment whether or not the redundancy degree of the data (the total repeating number of same data pattern) is more than the predetermined value based on the redundancy degree of the data judged and the set threshold (S22). The compression judgment flag generation logical circuit 34, when the redundancy degree of the data is more than the set threshold, judges that the data have the redundancy more than the predetermined value (the high redundancy) and creates the compression judgment flag “fg” having a value “1”.

(Compression Judgment Flag Generation Logical Circuit)

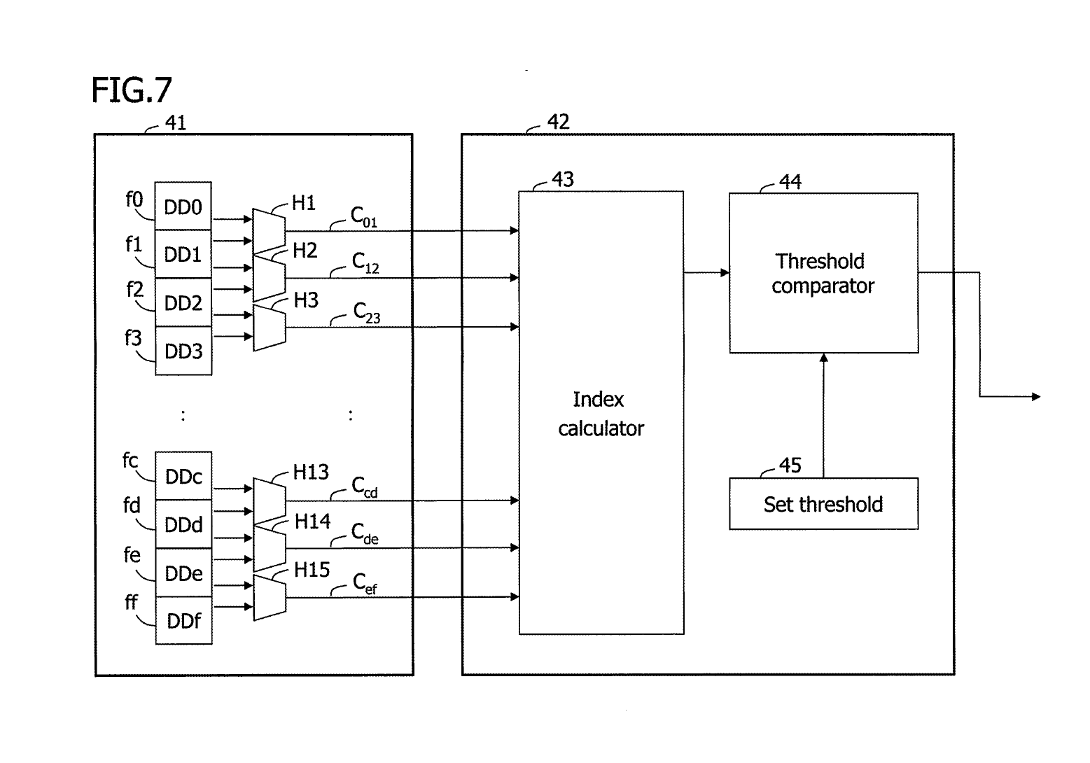

FIG. 7 is a diagram explaining an example of the hardware constitution of the compression judgment flag generation logical circuit 34. The compression judgment flag generation logical circuit 34 in FIG. 7 is a circuit which judges the redundancy of the data of 64 bit, for example.

The compression judgment flag generation logical circuit 34 in FIG. 7 includes a comparison unit 41 and a redundant judgment unit 42, as described in FIG. 2. The comparison unit 41 has sixteen pieces of flip-flops f0-ff and fifteen pieces of comparators H1-H15. In addition, the redundant judgment unit 42 includes, for example, an index calculator 43 and a threshold comparator 44.

Each of the flip-flops f0-ff holds an unit data which is divided the data of 64-bit stored in the data memory 38 of the temporarily store unit 31 into 4-bit and outputs it. In addition, each of the comparators H1-H15 compares output values (value of 4-bit) DD0-DDf from adjacent flip-flops f0-ff each other and outputs comparison results C01-Cef (C i, i+1) to the index calculator 43. Each of the comparators H1-H15, when output values from the flip-flops f0-ff matches with each other, outputs output values C01-Cef having the value “0” (match of data pattern), and when the output values from the flip-flops f0-ff do not match with each other, outputs output values C01-Cef having the value “1” (mismatch of data pattern).

In addition, the index calculator 43 adds up the output values C01-Cef from each of the comparators H1-H15. And threshold comparator 44 compares the set threshold 45 with the total value (number of mismatch) which outputs from the index calculator 43 and outputs the value “1” (as a high redundancy) as the compression judgment flag “fg” when the total values is not more than the threshold 45 and outputs the value “0” (as a low redundancy) as the compression judgment flag “fg” when the total values is more than the threshold 45.

The compression judgment flag generation logical circuit 34 of FIG. 7 generates the compression judgment flag “fg” with one clock, for example. In other words, the compression judgment flag generation logical circuit 34 generates the compression judgment flag “fg” which indicates whether the data have the redundancy degree more than a predetermined value immediately easily when new data are stored. The threshold 45 is set according to the data compression rate by the run length encoding. Therefore, that the data have the redundancy degree more than a predetermined value means that the data have compression rate corresponding to the threshold according to the run length encoding. Therefore, it is possible that the compression judgment flag generation logical circuit 34 judges whether the data have compression rate corresponding to the threshold easily based on the redundancy degree of the data.

The process of the compression judgment flag generation logical circuit 34 in FIG. 7 will be explained by using a specific example. In the embodiment, for example, the threshold is value “4”. When it is the threshold “4”, when the mismatch number of unit data patterns in the data of 64 bit is less than the threshold value “4”, the compression judgment flag generation logical circuit 34 outputs the compression judgment flag “fg” having value “1” as a high redundancy degree. And in the run length encoding, the data length after the compression becomes ½ when the number of data patterns of different patterns in the data of 64 bit is less than the threshold value “4”.

More specially, the case that data “0xffffddddeeeeaaaa” of 64 bit is inputted will be explained as a specific example. In response to the input of the data “0xffffddddeeeeaaaa”, sixteen pieces of flip-flops f0-ff holds unit data “0xf”, “0xf”, “0xf”, “0xf”, “0xd”, “0xd”, “0xd”, “0xd”, “0xe”, “0xe”, “0xe”, “0xe”, “0xa”, “0xa”, “0xa”, “0xa” of which each have. That is, the flip-flops f0-f3 hold data “0xf” respectively. In addition, the flip-flops f4-f7, the flip-flops f8-fb, and the flip-flops fc-ff respectively hold data “0xd”, data “0xe” and data “0xa”.

The comparator H1 compares an output value “0xf” of the flip-flop f1 with an output value “0xf” of the flip-flop f0 and outputs “C01” having value “0” because the both output values match with each other. In addition, each of the comparators H2, H3 outputs “C12”, “C23” each having a value “0”, too. On the other hand, the comparator H4 (not illustrated in FIG. 7) compares an output value “0xd” from the flip-flop f4 with an output value “0xf” from the flip-flop f3, and outputs “C34” having a value “1” because both values do not match with each other. Similarly, the comparators H5-H7 and H9-H11 (not illustrated in FIG. 7) output values “0”, and the comparator H8, H12 (not illustrated in FIG. 7) outputs values “1”. And the comparators H13-H15 output “Ccd”, “Cde”, “Cef” having a value “0” because the output values from the flip-flops fc-ff are same.

In other words, the comparators H1-H3, the comparators H5-H7, and the comparators H9-H11 output the value “0”, and the comparator H4, H8, H12 output the value “1” when the 64 bit-data “0xffffddddeeeeaaaa” is input. The index calculator 43 adds up the output values C01-Cef from the comparators H1-H15, and outputs a total value “3”. The threshold comparator 44 compares the total value “3” with the threshold value “4”, and outputs the value “1” as the compression judgment flag “fg” because the total value is smaller than the threshold value.

As described in the specific example, the data has four kind of data patterns (in this example, “0xffff”, “0xdddd”, “0xeeee” and “0xaaaa”) when the total value of the index calculator 43 is “3” (the total number of mismatching unit data). According to the run length encoding as described in FIG. 4B, the data length of the data (in this example “0x4f4d4e4a”) after the compression becomes ½ of the original data, when the number of different data patterns is four. When the threshold is set to the value “4”, the condition that the compression judgment flag “fg” becomes to the value “1” is described as a following expression 1.

Σ−Ci i+1(i=0˜e)<4 Expression 1

The expression 1 indicates the condition that the total value of output values C01-Cef from the comparators H1-H15 is less than the threshold “4”. When the condition is satisfied, the compression judgment flag generation logical circuit 34 outputs the compression judgment flag “fg” having the value “1”, because the data length after the compression becomes less than ½. On the other hand, the compression judgment flag generation logical circuit 34 outputs the compression judgment flag “fg” having value “0” when the total value of the output values Ci i+1 are more than the threshold “4”, because the data length does not become less than ½ of the original data.

In addition, for example, the case, in which data “0xaabbccccddddeeee” having five type of data patterns is inputted into, will be explained. When inputted the data “0xaabbccccddddeeee”, the comparators H1, H3, the comparator H5-H7, and the comparators H9-H11 output the value “0”(match), and the comparators H2, H4, H8, H12 output the value “1” (mismatch). Therefore, the index calculator 43 adds up the output values C01-Cef from the comparators H1-H15, and outputs the total value “4”. The threshold comparator 44 compares the threshold value “4” with the total value “4” and outputs the compression judgment flag “fg” having the value “0”.

The data “0xaabbccccddddeeee” has five type of data patterns, and the data length of the data “0x2a2b4c4d4e” after the compression is more than ½ of the original data. Therefore, the compression judgment flag generation logical circuit 34 determines that the data do not have the redundancy degree more than a predetermined value, and outputs the compression judgment flag “fg” of value “0”.

In addition, the compression judgment flag generation logical circuit 34 is described for data of 64 bit in FIG. 7, but the circuit is not limited to this example. That is, when the length of the target data is different, the constitution of the compression judgment flag generation logical circuit 34 may be used as different one. In addition, the threshold is described as the value “4” in the specific example, but the threshold is limited to this value. The threshold is set depending on the predetermined compression rate of the data appropriately. Next, another case that the threshold is value “2” will be explained.

When the threshold value is “2”, the compression judgment flag generation logical circuit 34 determines that the data has a redundancy degree more than a predetermined value when the number of kind of data patterns in the data is less than a value “2”, and outputs the compression judgment flag “fg” having the value “1”. According to the run length encoding as described in FIG. 4B, the data length of the data after the compression becomes ¼ of the original data, when the mismatch number of unit data patterns is less than two. Therefore, the compression judgment flag generation logical circuit 34 generate the compression judgment flag “fg” having the value “1” when the number of the outputs having the value “0” among the output values C i i+1 from the comparators is less than a value “2”. When the threshold is set to the value “2”, the condition that the compression judgment flag “fg” becomes to the value “1” is described as a following expression 2.

Σ−Ci i+1(i=0˜e)<2 Expression 2

The expression 2 indicates the condition that the total value of output values C i i+1 is less than the threshold “2”. When the condition is satisfied, the compression judgment flag generation logical circuit 34 outputs the compression judgment flag “fg” having the value “1”, because the data length after the compression becomes less than ¼ of the original data. On the other hand, the compression judgment flag generation logical circuit 34 outputs the compression judgment flag “fg” having value “0” when the total value of the output values Ci i+1 are more than the threshold “2”, because the data length does not become less than ¼ of the original data.

In other words, as illustrated by FIG. 6 and FIG. 7, the compression judgment flag generation logical circuit 34 outputs the compression judgment flag “fg” of value “1” when the data has the redundancy degree more than a predetermined value, that is, when the data has compression rate corresponding to the threshold.

(Correct or Incorrect Judgment Process of the Compression of Data)

Next, the Correct or incorrect judgment process of the compression of data base on the compression judgment flag “fg” according to the embodiment will be explained.

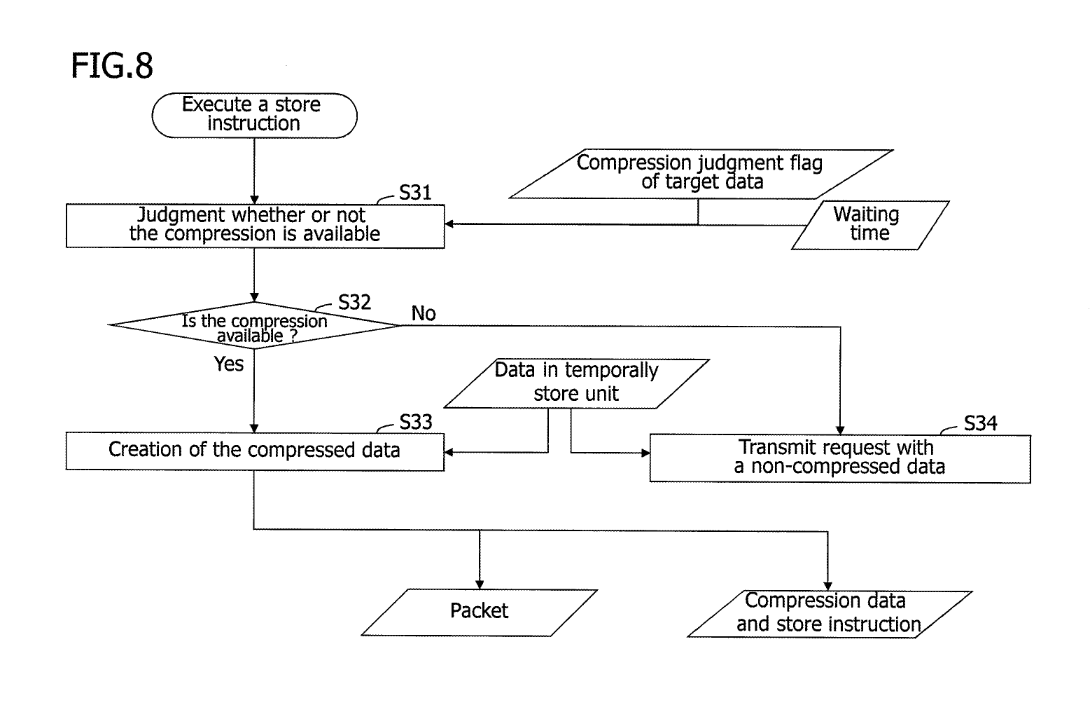

FIG. 8 is a flow diagram explaining that the compression judgment unit 61 of the memory control unit 23 (referring to FIG. 2) executes the processing of the correct or incorrect judgment process of the compression of data according to the embodiment. The flow in FIG. 8 will be explained by referring to FIG. 2. The compression judgment unit 61 judges whether or not the compression of the data is available based on the compression judgment flag “fg” and the waiting time until the transfer start of the instruction when the request of the instruction is executed (S31).

The compression judgment flag check unit 63 (referring to FIG. 2) in the compression judgment unit 61 confirms the compression judgment flag “fg” of which the compression judgment flag generation logical circuit 34 outputs and judges whether the data have the redundancy degree more than the predetermined value. In addition, the request waiting time confirmation unit 62 acquires the waiting time about the instruction that data have the redundancy degree more than the predetermined value based on the request waiting time counter 52. And the compression judgment unit 61 judges whether or not the compression of the data is available as follows. The request waiting time counter 52 holds the waiting time based on the instructions of the waiting of the transfer.

Specially, the compression judgment unit 61 judges whether or not the data is compressed based on start time for sending out of data (that is, waiting time until a transfer start to the memory) and the compression time for data. In addition, the compression judgment unit 61 judges whether or not the data is compressed based on a first sending out time to the memory of compressed data when performs the compression and a second sending out time to the memory of the non-compressed data when do not compress. In addition, the compression judgment unit 61 executes the judgment process of step S31 about an instruction when all compression judgment flags “fg” corresponding to the packets p1-pn are the value “1” when the instruction has a plurality of data packets p1-pn as depicted by FIG. 3.

More specially, when the compression judgment flag “fg” has value “0” (low redundancy), in other words, when the data do not have the redundancy more than a predetermined value, the compression judgment unit 61 judges that a desired compression rate is not obtained even if the compression is performed, and determines that the compression does not perform. On the other hand, when the compression judgment flag “fg” has value “1”, the request waiting time confirmation unit 62 judges that the compression is performed when satisfying the condition “the waiting time>=the compression time”. The compression judgment unit 61 calculates the compression time for data based on the length of the data, for example.

Even if the data have the redundancy more than the predetermined value, depending on the number of the logic steps for the compression of data (compression time), the time suffers from the compression of data. Therefore, the transfer completion of the instruction may become later than a case which does not compress data. Here, for example, the transfer completion timing of the instruction indicates to a timing when sending out to memory 30 of the data is completed. In addition, a first time, of which the sending out to the memory 30 of the compressed data takes (called as a first sending out time as follows), is shorter than a second time, of which the sending out to the memory 30 of the non-compressed data (called as a second sending out time as follows).

Therefore, a timing of the transfer completion of the instruction in a case which compress the data becomes earlier than a timing of the transfer completion of the instruction in a case which does not compress the data, when the condition “waiting time>=compression time” is satisfied, because the sending out time of the compressed data is shorter than the sending out time of the non-compressed data. Therefore, the compression judgment unit 61 judges that the compression is performed when the data have the redundancy more than the predetermined value and the condition “waiting time>=compression time” is satisfied.

However, even if does not satisfy the condition “waiting time>=compression time”, that is, even if a case is “the waiting time<compression time”, there is a case that the transfer completion of the compressed data may become earlier than the transfer completion of non-compressed data, by performing the compression.

Specially, when satisfying the condition of “(the waiting time+the sending out time of the non-compressed data to the memory 30)>(the compression time+the sending out time of the compressed data to the memory 30)”, the transfer of the instruction of the compressed data earlier completes than a case of the non-compressed data. That is, when the sending out time for the data largely decreases by the compression of data, even if satisfying a condition “the waiting time<the compression time”, a condition of “(the waiting time+the sending out time of the non-compressed data to the memory 30)>(the compression time+the sending out time of the compressed data to the memory 30)” is established.

The compression judgment unit 61 judges each time to take from the sending out to the memory 30 based on the data length of the compressed data and the non-compressed data, for example. The compression judgment unit 61 calculates the sending out completion time of data when the compression is performed based on the total time with the sending out time for the compressed data and the compression time. In addition, the compression judgment unit 61 calculates the sending out completion time of data when the compression is not performed based on the total time with the waiting time and the sending out time for the non-compressed data. And the compression judgment unit 61 determines that the compression is performed, when the transfer completion time of the instruction when performing the compression is earlier than the transfer completion time of the instruction when the compression is not performed.

Referring back to FIG. 8, when determining that it is available to compress (S32/YES), the data compressor 54 compresses the data output from the compression judgment unit 61, and generates the compressed data (S33). In addition, the packet generation unit 53 generates a packet having the header information of the data and a packet including the compressed data as a payload. And the request arbitration unit 51 performs a request of the instruction when the transfer of the precedent instruction is completed.

In addition, the sending out time to the memory 30 for data decreases, because the size of the data decreases when compressing the data. Therefore, the request arbitration unit 51 updates the request waiting time counter 52 based on the transfer time for data when compressing the data. In other words, the request arbitration unit 51 decrements the request waiting time counter 52 for the decreased transfer time for the instruction, which decreases by the compression of data when compressing the data.

On the other hand, when it is not judged to the compress is available (S32/NO), the packet generation unit 53 generate a packet including the data of the non-compression as a payload and the request arbitration unit 51 performs a request of the instruction when the transfer of the precedent instruction is completed (S34).

In addition, the arithmetic processing device 20 in the embodiment generates the compression judgment flag “fg” by the compression judgment flag generation logical circuit 34 for data held at a predetermined time in the temporally store unit 31. Accordingly, when a queue in the request arbitration unit 51 does not have an instruction which awaits the transfer, that is, when it is available to request the issued instruction immediately, the compression judgment flag generation logical circuit 34 does not need to generate the compression judgment flag “fg”. In this case, for example, the request arbitration unit 51 requests the store instruction without compressing the data held in the temporally store unit 31.

Next, the step S31 of the compression availability judgment process of the data depicted by FIG. 8 will be explained based on a specific example.

### Specific Example

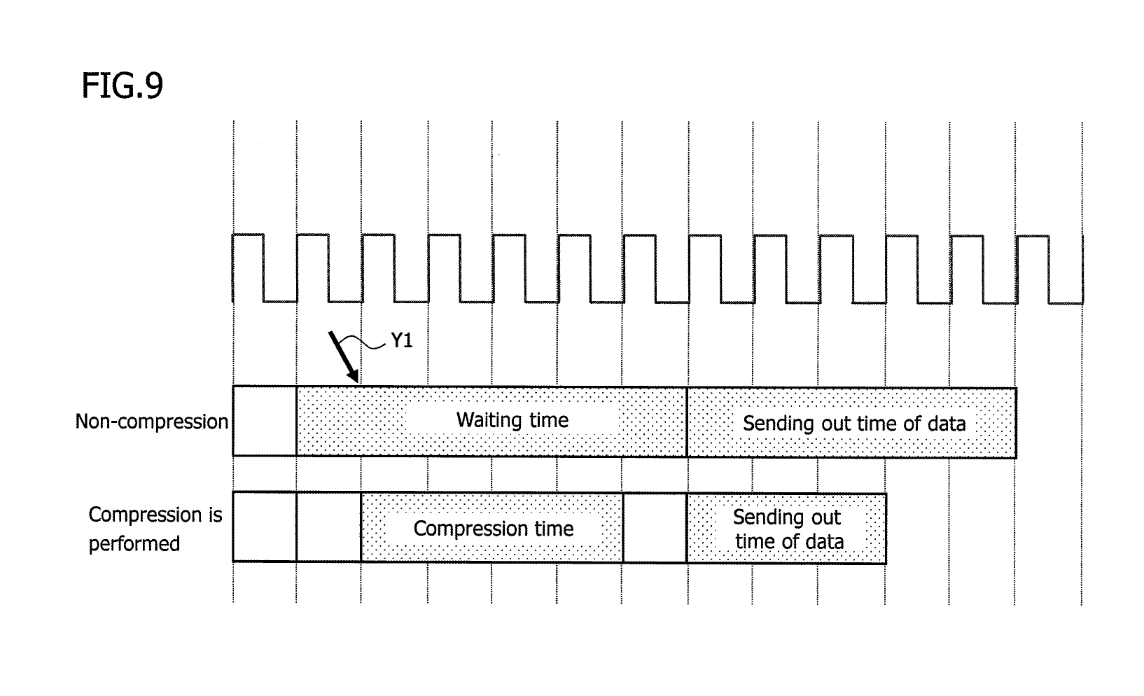

FIG. 9 is a timing chart diagram explaining the specific example of process S31 in FIG. 8 (the compression availability judgment process of the data) according to the embodiment. In other word, FIG. 9 is a figure indicating the transfer time for the instruction when the data is compressed and when the data is not compressed. In addition, in this example, a case to perform the judgment process for store instructions. In addition, in this example, the compression judgment flag “fg” of the target store instruction, which indicates data having predetermined redundancy, is value “1” (a high redundancy). An arrow Y1 in FIG. 9 indicates the timing when a store instruction is requested.

In FIG. 9, in a case when the compress is not performed (a case without the compression), the sending out time of the data is calculated based on the data length of the non-compressed data. Similarly, in a case when the compress is performed (a case with the compression), the compression time is calculated based on the data length of the non-compressed data and the sending out time of the data is calculated based on the data length of the compressed data.

When the store instruction is requested in a timing Y1, the compression judgment unit 61 compares the compression time with the waiting time based on the request waiting time counter 52. In the example of FIG. 9, the condition of “waiting time>=compression time” is satisfied. Therefore, the compression judgment unit 61 determines to compress the data. In the example of FIG. 9, the sending out time of the compressed data is 3 clocks whereas the sending out time of the non-compressed data is 5 clocks. Therefore, when the sending out of data is started after the waiting time, the transfer of the instruction in the compression is earlier completed than that in the non-compression.

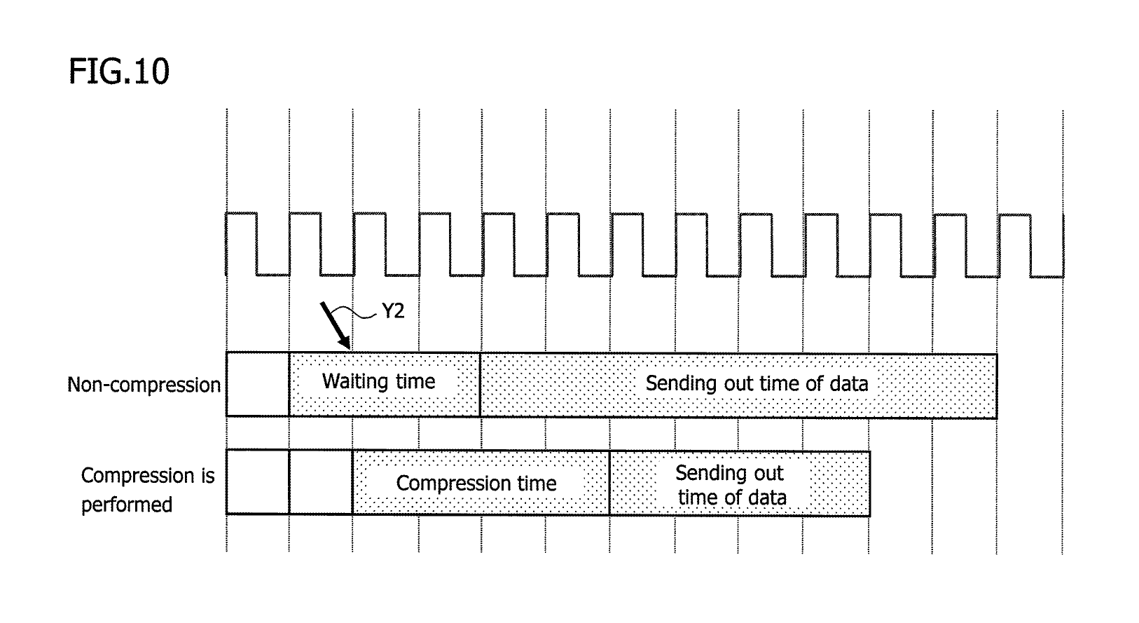

FIG. 10 is a timing chart diagram explaining another specific example of process S31 in FIG. 8 (the compression availability judgment process of the data) according to the embodiment. In other word, FIG. 10 is a figure indicating the transfer time for the instruction when the data is compressed and when the data is not compressed. In addition, in this example, a case to perform the judgment process for store instructions. In addition, in this example, the compression judgment flag “fg” of the target store instruction, which indicates data having predetermined redundancy, is value “1”. An arrow Y2 in FIG. 10 indicates the timing when a store instruction is requested. As similar to FIG. 9, the sending out time of the data when compression and when non-compression is calculated, and the compression time of data is calculated.

When the store instruction is requested in a timing Y2, the compression judgment unit 61 compares the compression time with the waiting time based on the request waiting time counter 52. In the example of FIG. 10, the condition of “waiting time>=compression time” is not satisfied. That is, the completion of data does not complete during the waiting time. However, another condition of “(the waiting time+the sending out time of the non-compressed data to the memory 30)>(the compression time+the sending out time of the compressed data to the memory 30)” is satisfied. Therefore, the compression judgment unit 61 determines to compress the data.

In the example of FIG. 10, because of “the waiting time<the compression time”, when compressing the data, the sending out of the compressed data is started at the completion of the compression after elapsing the waiting time. In example of FIG. 10, the sending out time of the compressed data is 4 clocks whereas the sending out time of the non-compressed data is 8 clocks. That is, the sending out time is largely decreased by the compression. Therefore, even though the transferring of the instruction is started after the compression of the data, the transfer of the instruction in the compression is earlier completed than that in the non-compression.

As illustrated by FIG. 9, and FIG. 10, the memory control unit 23 judges whether or not the compression of the data is performed only for the instructions having the redundancy degree more than the predetermined value. That is, the memory control unit 23 judges whether or not the compression of the data is performed based on the waiting time until the transfer start to the memory, the compression time to take the compression of the data, and sending time of the compressed data when the compression is performed and a sending time of the non-compressed data when the compression is not performed. And it is possible that the memory control unit 23 compresses the data when judging to compress the data. In addition, the memory control unit 23 judges whether the data have desired compression rate based on the redundancy degree of the data. Therefore, it is possible to judge whether or not the compression of data is performed based on the waiting time at an early stage.

As above described, the arithmetic processing device 20 according to the embodiment, has an arithmetic processing unit which issues an instruction accompanying with data which is sent to a memory, an judgment unit which judges whether or not a redundancy degree of the data which is accompanied with the instruction is more than a predetermined value, and a compression unit which judges whether or not compresses the data based on an waiting time until a transfer start of the instruction to the memory and a compression time to take the compression of the data when the redundancy degree of the data is more than the predetermined value. Further, the arithmetic processing device 20 has an instruction arbitration unit which transfers the instruction accompanying with the compressed data when the compression unit performs the compression and the instruction accompanying with the non-compressed data when the compression unit does not perform the compression.

In this way, it is possible that the arithmetic processing device easily judges whether the data has a compression rate corresponding to a predetermined value because judging whether the data has the redundancy degree more than a predetermined value. In addition, because the arithmetic processing device judges whether the data has the compression rate corresponding to the predetermined value without compressing the data, it is possible to judge whether or not performs the compression of the data based on the waiting time until a transfer start to the memory of the instruction and the compression time at an early stage.

It is possible that the arithmetic processing device increases time to compress data since it become able to determine whether the compression is performed at an early stage. Therefore, it is possible that the arithmetic processing device compresses more data, thereby it is possible to improve an efficiency of the band width with the CPU and the memory. In addition, it is possible to avoid unnecessary compression process since it become able to determine whether or not the compression of data is performed without compressing data.

In addition, the compression unit in the arithmetic processing device 20 according to the embodiment judges that the compression is performed when the compression time is within the waiting time. It is possible that the arithmetic processing device determines whether the transfer completion of the instruction becomes early by comparing the waiting time with the compression time by performing the compression of data.

In addition, the compression unit in the arithmetic processing device 20 according to the embodiment judges whether or not the compression is performed based on the sending out time of the compressed data to the memory and the sending out time of the non-compressed data to the memory. Therefore, it is possible that the arithmetic processing device 20 judges whether or not the transfer completion of the instruction becomes early by performing the compression, based on the sending out time of the compressed data to the memory and the sending out time of the non-compressed data to the memory. Further, it is possible the arithmetic processing device 20 compresses more data having the redundancy degree more than the predetermined value based on the sending out time of the compressed data to the memory and the sending out time of the non-compressed data to the memory in addition to the compression time and the waiting time.

In addition, the compression unit in the arithmetic processing device 20 according to the embodiment, calculates a first sending out end time of the compressed data and a second sending out end time of the non-compressed data, based on the waiting time and the compression time, and determines to compress when the first sending out end time is earlier than the second sending out end time. Therefore, it is possible that the arithmetic processing device 20 appropriately judges whether or not compresses the data without compressing data, since the compression unit calculates the first sending out end time of the compressed data and the second sending out end time of the non-compressed data based on the waiting time and the compression time, and determines to compress when the first sending out end time is earlier than the second sending out end time.

In addition, the compression unit of the arithmetic processing device 20 in the embodiment calculates the first sending out end time based on the total time with the compression time and the sending out time of the compressed data and the second sending out end time based on the total time with the wait time and the sending out time of the non-compressed data. It is possible that the arithmetic processing device 20 easily calculates the first sending out end time and the second sending out end time.

In addition, the judgment unit of the arithmetic processing device 20 in the embodiment calculates the matching rate between adjacent unit data which are divided the data into a predetermined bit length, and judges that the redundancy degree is more than the predetermined value when the matching rate is more than a reference value. It is possible that the arithmetic processing device 20 easily judges that the redundancy degree is more than the predetermined value when the matching rate is more than a reference value.

In addition, the judgment unit of the arithmetic processing device 20 in the embodiment has a plurality of first arithmetic unit which outputs the first value when the adjacent unit data are matched and outputs the second value which is different from the first value when the adjacent unit data are mismatched, and a second arithmetic unit which compare a total value of the output values from the plurality of the first arithmetic unit with the total value of the reference. It is possible that the arithmetic processing device 20 judges whether or not the data has a redundancy degree more than the predetermined value based on the outputs of the first and second arithmetic unit, thereby it is possible to easily judge whether or not the data has a predetermined compression rate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
an arithmetic processing unit configured to issue an instruction accompanying with data which is sent to a memory;
a judgment unit configured to judge whether or not a redundancy degree of the data which is accompanied with the instruction is more than a predetermined value;
a compression unit configured to judge whether or not compress the data based on an waiting time until a transfer start of the instruction to the memory and a compression time to take the compression of the data when the redundancy degree of the data is more than the predetermined value, and compress the data when judging that performs the compression; and
an instruction arbitration unit configured to transfer the instruction accompanying with the compressed data from the arithmetic processing unit to the memory when the compression unit performs the compression and transfer the instruction accompanying with the non-compressed data from the arithmetic processing unit to the memory when the compression unit does not perform the compression.

2. The arithmetic processing device according to claim 1, wherein the judgment unit is configured to judge whether or not a redundancy degree of the data is more than the predetermined value corresponding to a predetermined compression rate of the data.

3. The arithmetic processing device according to claim 1, wherein the compression unit is configured to judge that the compression is performed when the compression time is within the wait time.

4. The arithmetic processing device according to claim 1, wherein the compression unit is configured to further judge whether or not compress the data based on a first sending out time of a compressed data to the memory and a second sending out time of a non-compressed data to the memory.

5. The arithmetic processing device according to claim 4, wherein the compression unit is configured to further calculate a first sending out end time of the compressed data and a second sending out end time of the non-compressed data, based on the wait time, the compression time and the first and second sending out times, and judge that compression is performed when the first sending out end time of the compressed data is earlier than the second sending out end time of the non-compressed data.

6. The arithmetic processing device according to claim 5, wherein the compression unit is configured to further calculate the first sending out end time of the compressed data based on total time of the compression time and the first sending out time of the compressed data, and calculate the second sending out end time of the non-compressed data based on total time of the wait time and the second sending out time of the non-compressed data.

7. The arithmetic processing device according to claim 1, wherein the judgment unit is configured to detect whether or not adjacent plural unit data are matched among a plurality of unit data which are divided the data in a predetermined bit length, compare a number of match of the unit data with a threshold and determine that redundancy degree of the data is more than the predetermined value by a result of comparison.

8. The arithmetic processing device according to claim 7, wherein the judgment unit comprising:
a plurality of first arithmetic unit configured to output a first value when the adjacent unit data are matched and output a second value which is different from the first value when the adjacent unit data are mismatched; and
a second arithmetic unit configured to compare a total value of the output values from the plurality of the first arithmetic unit with the threshold.

9. The arithmetic processing device according to claim 8, wherein the second arithmetic unit comprising:
a calculation unit configured to calculate the total value of the output values; and
a comparison unit configured to compare the total value of the output values from the plurality of the first arithmetic unit with the threshold.

10. The arithmetic processing device according to claim 1, wherein the compression unit is configured to compress the data by run length encoding.

11. An information processing device comprising:
a memory; and
an arithmetic processing device including;
an arithmetic processing unit configured to issue an instruction accompanying with data which is sent to the memory;
a judgment unit configured to judge whether or not a redundancy degree of the data which is accompanied with the instruction is more than a predetermined value;
a compression unit configured to judge whether or not compress the data based on an waiting time until a transfer start of the instruction to the memory and a compression time to take the compression of the data when the redundancy degree of the data is more than the predetermined value, and compress the data when judging that performs the compression; and
an instruction arbitration unit configured to transfer the instruction accompanying with the compressed data from the arithmetic processing unit to the memory when the compression unit performs the compression and transfer the instruction accompanying with the non-compressed data from the arithmetic processing unit to the memory when the compression unit does not perform the compression.

12. The information processing device according to claim 11, wherein the judgment unit is configured to judge whether or not a redundancy degree of the data is more than the predetermined value corresponding to a predetermined compression rate of the data.

13. The information processing device according to claim 11, wherein the compression unit is configured to judge that the compression is performed when the compression time is within the wait time.

14. The information processing device according to claim 11, wherein the compression unit is configured to further judge whether or not compress the data based on a first sending out time of a compressed data to the memory and a second sending out time of a non-compressed data to the memory.

15. The information processing device according to claim 14, wherein the compression unit is configured to further calculate a first sending out end time of the compressed data and a second sending out end time of the non-compressed data, based on the wait time, the compression time and the first and second sending out times, and judge that compression is performed when the first sending out end time of the compressed data is earlier than the second sending out end time of the non-compressed data.

16. The information processing device according to claim 15, wherein the compression unit is configured to further calculate the first sending out end time of the compressed data based on total time of the compression time and the first sending out time of the compressed data, and calculate the second sending out end time of the non-compressed data based on total time of the wait time and the second sending out time of the non-compressed data.

17. The information processing device according to claim 16, wherein the judgment unit is configured to detect whether or not adjacent plural unit data are matched among a plurality of unit data which are divided the data in a predetermined bit length, compare a number of match of the unit data with a threshold and determine that redundancy degree of the data is more than the predetermined value by a result of comparison.

18. A method of controlling an information processing device having an arithmetic processing unit and a memory, the method comprising:
issuing an instruction accompanying with data which is sent to the memory by the arithmetic processing unit;
judging whether or not a redundancy degree of the data which is accompanied with the instruction is more than a predetermined value by the arithmetic processing unit;
second judging whether or not compress the data based on an waiting time until a transfer start of the instruction to the memory and a compression time to take the compression of the data when the redundancy degree of the data is more than the predetermined value, and compressing the data when judging that performs the compression by the arithmetic processing unit; and
transferring the instruction accompanying with the compressed data from the arithmetic processing unit to the memory when judging that performs the compression and transferring the instruction accompanying with the non-compressed data from the arithmetic processing unit to the memory when judging that the compression is not performed.

19. The method of controlling the information processing device according to claim 18, the judging comprising judging whether or not the redundancy degree of the data is more than the predetermined value corresponding to a predetermined compression rate of the data.

20. The method of controlling the information processing device according to claim 18, wherein the method further comprising third judging that the compression is performed when the compression time is within the wait time.
